(19) United States
(12) Patent Application Publication
(10) Pub. No.: US 2002/0089934 A1
(43) Pub. Date: Jul. 11, 2002

(54) System and method for identifying congested links in computer network

(75) Inventors: Alexander V. Sokhin, Nashua, NH (US); Andrey Zawadowskiy, Nashua, NH (US)

Correspondence Address: Richard A. Jordan, P. O. Box 81363, Wellesley Hills, MA, 02481-0004, US

(73) Assignee: Urrahx Corporation

(21) Appl. No.: 09/757,270

(22) Filed: Jan. 9, 2001

(51) Int. Cl. G06F 11/00; H04L 1/00; H04L 12/28

(52) U.S. Cl. 370/237; 370/230; 370/254

(57) ABSTRACT

A congested link identification system is configured to be used in connection with a network for facilitating transfer of message packets among a plurality of information utilization devices. The network comprises a plurality of switching nodes interconnected by a plurality of communication links, at least some of the information utilization devices being configured to transfer message packets thereamong over paths through the network, with each path comprising at least one communication link. The congested link identification system comprises a plurality of congestion detection agents and a congestion link identification processor. Each congestion detection agent is associated with one of the information utilization devices. Each congestion detection agent is configured to generate congested path information indicating whether respective paths used by the information utilization device associated with the respective congestion detection information are congested. The congestion link identification processor is configured to process the congestion detection information generated by the congestion detection agents to identify communication links that are congested.

### FIELD OF THE INVENTION

The invention relates generally to the field of digital data networks, and more particularly to systems and methods for identifying which, if any, of the communication links used to transfer message packets in respective networks are congested.

### BACKGROUND OF THE INVENTION

Digital networks have been developed to facilitate the transfer of information, including data and programs, among digital computer systems and other digital devices. Typically, a network includes a plurality of switching nodes interconnected by communication links that are configured to transfer information in the form of message packets. Problems arise if too many devices wish to contemporaneously transfer information packets over paths that utilize the same communication link. When that occurs, the switching node that transmits message packets over that communication link can experience congestion in connection with that communication link. Congestion may lead to unacceptably long times to transfer message packets, congestion in other communication links, and may even require the switching node or nodes that are experiencing congestion to discard message packets. Accordingly, it is desirable to be able to determine locations in a network at which congestion occurs so that corrective action, such as increasing message packet transfer bandwidth, re-routing of message transfer paths away from the points of congestion, and the like, can be undertaken.

### SUMMARY OF THE INVENTION

The invention provides a new and improved system and method for identifying congested communication links in a digital data network.

In brief summary, the invention provides a congested link identification system configured to be used in connection with a network for facilitating transfer of message packets among a plurality of information utilization devices. The network comprises a plurality of switching nodes interconnected by a plurality of communication links, at least some of the information utilization devices being configured to transfer message packets thereamong over paths through the network, with each path comprising at least one communication link. The congested link identification system comprises a plurality of congestion detection agents and a congestion link identification processor. Each congestion detection agent is associated with one of the information utilization devices. Each congestion detection agent is configured to generate congested path information indicating whether respective paths used by the information utilization device associated with the respective congestion detection information are congested. The congestion link identification processor is configured to process the congestion detection information generated by the congestion detection agents to identify communication links that are congested.

In one embodiment, the congested link identification processor comprises a network connectivity graph generation module, an edge link labeling module and a graph pruning module. The network connectivity graph generation module is configured to generate a network connectivity graph describing the topology of at least a portion of the network from the congested path information, the network connectivity graph including a plurality of vertices each associated with one of said switching nodes and edges each associated with one of said communication links. The edge link labeling module is configured to label the edges in the graph, each edge being labeled as being congested if the congested path information indicates that all of the paths that utilize the communication link associated with that edge are congested, and otherwise labeling the edge not congested. The graph pruning module is configured to prune the graph of edges that are labeled not congested, the edges that are not pruned being congested.

### BRIEF DESCRIPTION OF THE DRAWINGS

This invention is pointed out with particularity in the appended claims. The above and further advantages of this invention may be better understood by referring to the following description taken in conjunction with the accompanying drawings, in which:

FIG. 1 schematically depicts a digital data network for transferring information among a plurality of information utilization devices, and further including a system for identifying congested communication links, constructed in accordance with the invention;

FIG. 2 schematically depicts an illustrative network connectivity graph generated by the congested communication link identification system for the network depicted in FIG. 1, which is useful in understanding operations performed thereby in connection with detecting congested communication links; and

FIG. 3 is a flow chart depicting operations performed by the congested communication link identification system in connection with detecting congested communication links in the digital data network depicted in FIG. 1.

### DETAILED DESCRIPTION OF AN ILLUSTRATIVE EMBODIMENT

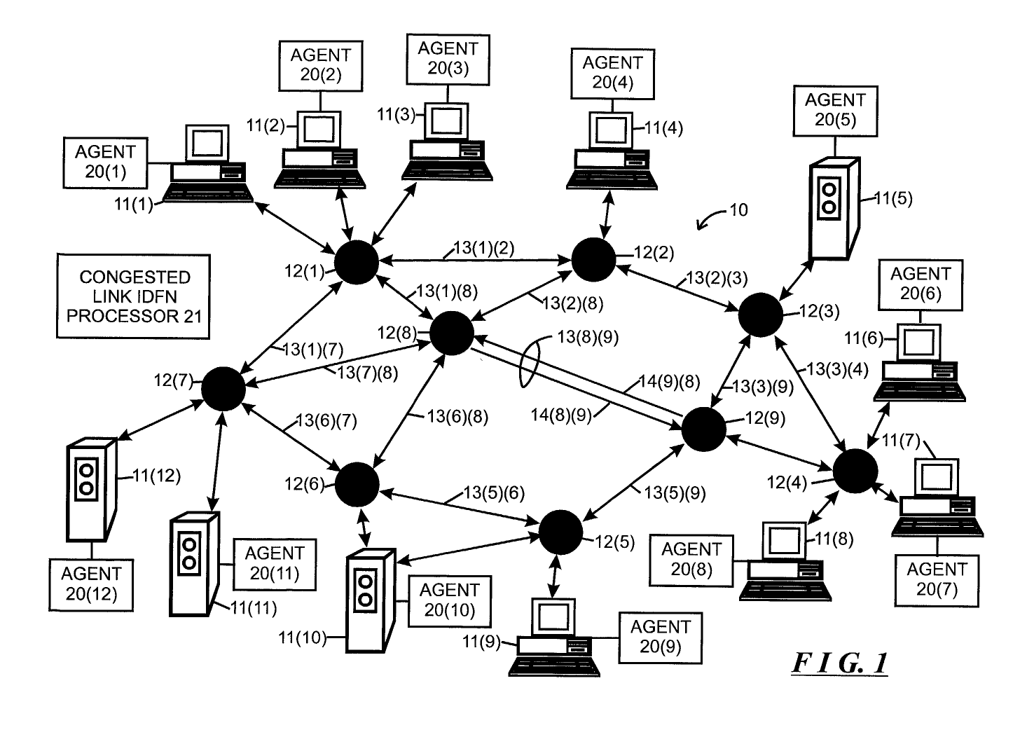

FIG. 1 schematically depicts a digital data network 10 for transferring information among a plurality of information utilization devices 11(1) through 11(N) (generally identified by reference numeral 11(n), and further including a system for identifying congested communication links constructed in accordance with the invention. With reference to FIG. 1, the digital data network 10 includes a plurality of switching nodes 12(1) through 12(M) interconnected by communication links, generally identified by reference numeral 13(m₁)(m₂). Each information utilization device 11(n) is also connected to one or more switching nodes 12(m) to enable them to transmit and/or receive information over the network.

The information utilization devices 11(n) may comprise any type of devices that may need to transmit or receive information over the network, including, for example, personal computers, computer workstations, mini- and mainframe computers. In addition, the information utilization devices 11(n) may comprise other types of devices, including, for example, network printers for providing hardcopy output, video display devices for retrieving and displaying video images, sensors for providing information for, for example, scientific analysis, and any other type of device that may generate or need to utilize digital information.

Communication links 13(m₁)(m₂) may comprise any type of communication link that can transfer information in a digital data network. The communication links 13(m₁)(m₂) preferably transfer information bidirectionally, and typically will comprise separate links 14(m₁)(m₂) and 14(m₂)(m₁), as shown specifically for communication link 13(8)(9). That is, communication link 13(m₁)(m₂) includes a link 14(m₁)(m₂) for transferring information from switching node 12(m₁) to switching node 12(m₂), and a link 14(m₂)(m₁) for transferring information from switching node 12(m₂) to switching node 12(m₁).

As is conventional, the information utilization devices 11(n) transfer information through the network in the form of message packets using any convenient communication protocol. The protocol may enable the information utilization devices 11(n) to transfer information using a “peer-to-peer” methodology or a “client-server” methodology, or both. Typically in a “peer-to-peer” protocol, any information utilization device 11(n) will transfer a message packet to any other information utilization device.

On the other hand, in a client-server protocol, generally one or more of the information utilization devices are designated as servers and others will be designated as clients. Servers typically store information that may be downloaded and used by the clients in their processing or other operations. In that operation, a client will generate one or more message packets requesting downloading of particular items of information, and transmit the message packet(s) to the particular server(s) on which the information items are stored. The server(s), after receiving the message packet(s) containing the download request, will process the request to obtain the requested information items from storage, load them into one or more message packets and transmit the message packet(s) to the client for utilization thereby.

The clients can also upload information to the servers for storage, and, in that operation, a client will generate one or more message packets storage of respective items of information by the server, the message packets including the information items to be stored, and transmit the message packet(s) to the particular server(s) on which the information items are to be stored. After receipt of the message packet(s), the server will store the information items. The clients may later download the uploaded information. The downloading of information stored on the servers may be restricted to, for example, the particular computers that uploaded the information or to particular users of those computers. Alternatively, any computer or user may download information stored on the servers. Transferring information according to a client-server methodology facilitates ready sharing of data among, for example, computers connected to the network and can allow users who have permission to access particular items of information to download the information to various computers that they may be using.

As noted above, the information is transferred in the form of message packets. An information utilization device 11(n′), as a source information utilization device 11(n_{S}), will generate a message packet for transfer to another information utilization device 11(n″), as a destination information utilization device 11(n_{D}), and transmit the message packet to a switching node 12(m₁). If the switching node 12(m₁) is also connected to the destination information utilization device 11(n_{D}), the switching node 12(m₁) can transfer the message packet to the information utilization device 11(n_{D}). However, if the switching node 12(m₁) is not connected to the destination information utilization device 11(n_{D}), it will transfer the message packet to another switching node 12(m₂), which will perform the same operations as switching node 12(m₁). Each switching node 12(m₁), 12(m₂), 12(m₃), . . . that receives the message packet will perform the same operations, until the message packet reaches a switching node 12(mₓ) that is connected to the destination information utilization device 11(n_{D}), that switching node 12(mₓ) will transfer the message packet to the destination information utilization device 11(n_{D}). The switching node or sequence of switching nodes 12(m₁), 12(m₂), . . . from the source information utilization device 11(n_{S}) to the destination information utilization device 11(n_{D}) defines the path for message packets transferred from the source information utilization device 11(n_{S}) to the destination information utilization device 11(n_{D}). The switching node or sequence of switching nodes over which the message packet is transferred will typically be selected so that the path will contain the minimum or, at least a relatively small, number of switching nodes 12(m).

Each path over which an information utilization device 11(n′) transmits message packets to another information utilization device 11(n″) may be associated with a “connection,” which, in turn, will be associated with a connection identifier. In that case, each message packet will include the connection identifier for the connection associated with the path over which the message packet is to be transferred. Each switching node 12(m), when it receives a message packet, can identify the communication link over which it is to transmit a message packet that it receives using the connection identifier in the respective message packet.

It will be appreciated that an information utilization device 11(n′) may operate as both a source information utilization device 11(n_{S}), to transmit information to other information utilization devices 11(n″), 11(n′″), . . . and a destination information utilization device 11(n_{D}) to receive information from other information utilization devices 11(n″), 11(n′″) . . . Some information utilization devices 11(n″″) may, on the other hand, operate only as source information utilization devices 11(n_{S}) or destination information utilization devices 11(n_{D}).

In any case, the switching nodes 12(m) will perform the operations described above for each message packet transferred between each pair of source and destination information utilization devices 11(n_{S}) and 11(n_{D}). It will be appreciated that at least portions of paths between at least some pairs of source and destination information utilization devices 11(n_{S}) and 11(n_{D}) will overlap, such that, for example, a switching node 11(n′) may contemporaneously receive several message packets over respective ones of the communication links 13 connected thereto, for transmission over the same communication link. In that case, since the switching node 11(n′) can only transmit one message packet at a time over a communication link 13, it will need to buffer at least some of the message packets while it transfers others over the communication link. Accordingly, depending on the rate at which a switching node 11(n′) contemporaneously receives message packets for transfer over the same communication link, congestion can develop as the switching nodes's buffer fills up and the switching node either has to discard message packets or attempt to regulate the flow of message packets thereto for transfer over the respective communication link. Congestion can, in addition to possibly leading to discarding of message packets, also lead to undesirably long delays n delivering message packets, which can, for example, unduly delay processing in the case of computers, unduly delay production of hardcopy output in the case of network printers, cause interruptions in display in the case of video displays, and so forth. Accordingly, if congestion develops, it is desirable to identify where the congestion is located to determine whether corrective action, such as routing, increasing bandwidth or the like, can be undertaken, if so desired.

The arrangement depicted in FIG. 1 is provided with a congested communication link identification system for identifying which, if any, of the communication links 13 are exhibiting congestion. The congested communication link identification system includes, at each information utilization device 11(n), an associated congestion detection agent 20(1) through 20(N) (generally identified by reference numeral 20(n)) and a congested link identification processor 21. Each congestion detection agent 20(n), which may be embodied in a software program running on the respective information utilization device 11(n). Each congestion detection agent 20(n′) generates congestion information indicating whether the associated information utilization device 20(n′) is experiencing congestion in connection with message packets received from or transmitted to other information utilization devices 20(n″), 20(n′″), . . . (n″, n′″. . . ≠n′) over respective paths thereto. The congested link identification processor 21 receives the congestion information from the congestion detection agents 20(n) and processes it to identify communication links 13, if any, that are congested.

As noted above, each congestion detection agent 20(n′) generates congestion information indicating whether the associated information utilization device 11(n′) is experiencing congestion in connection with message packets received from or transmitted to other information utilization devices 20(n″), 20(n′″), . . . (n , n″. . . ≠n′) over respective paths thereto. Each congestion detection agent 20(n′) can use any convenient methodology to determine whether the associated information utilization device 11(n′) is experiencing congestion, including, for example, whether message packets transmitted to the associated information utilization device 11(n′) from a respective other information utilization device 11(n″), 11(n′″), . . . are unduly delayed, taking into account the number of switching nodes 12(m) along the path from the other information utilization device 11(n″), 11(n′″), . . . to the information utilization device 11(n′). In that operation, the congestion detection agent 20(n′) can, for example, determine for each message packet the time period between the time at which the message packet was generated, as indicated by a time stamp provided in respective message packets, and the time at which the message packet is received.

If the time period is below a predetermined threshold value for a particular message packet, the threshold value preferably taking into account the number of switching nodes 12(m) along the path from the other information utilization device 11(n″), 11(n′″), . . . to the information utilization device 11(n′), the congestion detection agent 20(n′) can determine that that message packet had not experienced congestion. In that case, if the congestion detection agent 20(n′) had not previously marked the path from the other information utilization device 11(n″), 11(n′″), . . . to the information utilization device 11(n′) as being congested, it can mark the path as not being congested. On the other hand, if the time period is above the predetermined threshold value, the congestion detection agent 20(n′) can determine that that message packet had experienced congestion, and mark the path from the other information utilization device 20(n″), 20(n′″), . . . to the information utilization device 11(n′) associated with the congestion detection agent 20(n′) as being congested. It will be appreciated that, with this methodology, determinations as to whether a path is congested will be made by the congestion detection agents 20(n) associated with information utilization devices 11(n) that operate as destination information utilization devices 11(n_{D})

Alternatively or in addition, congestion detection agents 20(n) can determine that congestion arises in connection with a path if its associated information utilization device 11(n) receives a notification thereof. If, for example, a switching node 12(m), when it determines that a congestion condition exists in connection with communication link over which it is to transmit message packets, it can identify all of the connections for which that communication link forms part of the path, and transmit congestion notifications to the information utilization devices 11(n) which comprise source information utilization devices 11(n_{S}) that transmit message packets over those connections. Alternatively, the switching node 12(m), when it determines that the congestion condition exist, instead of transmitting congestion notifications to all such source information utilization devices 11(n_{S}), it can transmit the congestion notifications to each such source information utilization device 11(n_{S}) when it receives a message packet therefrom.

The congestion detection agent 20(n′) does not initially mark paths between its associated information utilization device 11(n′) and the other information utilization devices 11(n″), 11(n′″) . . . as being congested, because there may be no message packets transferred over some paths. In addition, after the congestion detection agent 20(n′) has marked a path as being congested, it will not thereafter change the mark to indicate that the path is not congested for reasons that will be made clear below.

The congestion detection agents 20(n) can operate over, for example, a predetermined time period. At some point in time, the congestion detection agents 20(n) will provide congestion information, which will be referred to as the “congested path information,” to the congested link identification processor 21, including the identifications of the paths that they have marked as being not congested and the paths that they have marked as being congested. The congested link identification processor 21, after receiving the congested path information, will process it to attempt to identify which communication links, if any, are congested. It will be appreciated that the congested path information identifies paths, rather than communication links, that are marked as being congested or not congested, and the congested link identification processor 21 processes the congested path information to identify which, if any, of the communication links 13 are congested. Generally, in that operation, the congested link identification processor 21 will identify congested communication links by determining the communication links, if any, for which congestion detection agents 20(n) associated with all of the information utilization devices 11(n) that have connections over the respective communication links report that they are congested. If at least one congested detection agent 20(n) reports that a path over one or more communication links is not congested, the congested link identification processor 21 will determine that none of the communication links that form the path are congested.

An example will help understand now the congested link identification processor 21 identifies congested communication links. With continued reference to FIG. 1, assume, for example, that the following paths are marked congested:

(i) one or more paths for transferring message packets from switching node 12(1), through switching nodes 12(8) and 12(9), to switching node 12(4);

(ii) one or more paths for transferring message packets from switching node 12(1), through switching nodes 12(8) and 12(9), to switching node 12(5);

(iii) one or more paths for transferring message packets from switching node 12(2) through switching node 12(8) and 12(9), to switching node 12(4);

(iv) one or more paths for transferring message packets from switching node 12(2) through switching node 12(8) and 12(9), to switching node 12(5);

(v) one or more paths for transferring message packets from switching node 12(7) through switching node 12(8) and 12(9), to switching node 12(3);

(vi) one or more paths for transferring message packets from switching node 12(7) through switching node 12(8) and 12(9), to switching node 12(4); and

(vii) one or more paths for transferring message packets from switching node 12(6) through switching node 12(8) and 12(9), to switching node 12(3).

On the other hand, assume that the following paths are marked not congested:

(a) one or more paths for transferring message packets from switching node 12(1) through switching node 12(8) to switching node 12(6);

(b) one or more paths for transferring message packets from switching node 12(2) At through switching node 12(8) to switching node 12(6);

(c) one or more paths for transferring message packets from switching node 12(2) through switching node 12(8) to switching node 12(7);

(d) one or more paths for transferring message packets from switching node 12(6) through switching node 12(8) to switching node 12(2);

(e) one or more paths for transferring message packets from switching node 12(7) through switching node 12(8) to switching node 12(2);

(f) one or more paths for transferring message packets from switching node 12(3) through switching node 12(9) to switching node 12(5);

(g) one or more paths for transferring message packets from switching node 12(5) through switching node 12(9) to switching node 12(3); and

(h) one or more paths for transferring message packets from switching node 12(5) through switching node 12(9) to switching node 12(4).

In that case, it will be apparent that the link 14(8)(9) for transferring message packets from switching node 12(8) to switching node 12(9) is congested. This follows from the fact that:

(A) the paths marked as being congested indicate that one or more of the following links may be congested:

(I) the link 14(1)(8) from switching node 12(1) to switching node 12(8) (reference (i) above);

(II) the link 14(2)(8) from switching node 12(2) to switching node 12(8) (reference (iii) and (iv) above);

(III) the link 14(6)(8) from switching node 12(6) to switching node 12(8) (reference (vii) above);

(IV) the link 14(7)(8) from switching node 12(7) to switching node 12(8) (reference (v) and (vi) above);

(V) the link 14(8)(9) from switching node 12(8) to switching node 12(9) (reference (i) through (vii) above);

(VI) the link 14(9)(3) from switching node 12(9) to switching node 12(3) (reference (v) and (vii) above);

(VII) the link 14(9)(4) from switching node 12(9) to switching node 12(4) (reference (i) and (iii) above);

(VIII) the link 14(9)(5) from switching node 12(9) to switching node 12(5) (reference (ii) and (iii) above);

(B) However, the congested path information indicates that the following communication links are not congested:

(I) the link 14(1)(8) from switching node 12(1) to switching node 12(8) (reference (a) above);

(II) the link 14(2)(8) from switching node 12(2) to switching node 12(8) (reference (b) and (c) above);

(III) the link 14(6)(8) from switching node 12(6) to switching node 12(8) (reference (d) above);

(IV) the link 14(7)(8) from switching node 12(7) to switching node 12(8) (reference (e) above);

(VII) the link 14(9)(3) from switching node 12(9) to switching node 12(3) (reference (f) above);

(VIII) the link 14(9)(4) from switching node 12(9) to switching node 12(4) (reference (h) above); and

(IX) the link 14(9)(5) from switching node 12(9) to switching node 12(5) (reference (g) above);

leaving (V), the link 14(8)(9) from switching node 12(8) to switching node 12(9), as being congested.

The congested link identification processor 21 processes the congested path information received from the congestion detection agents 20(n) in three steps, namely:

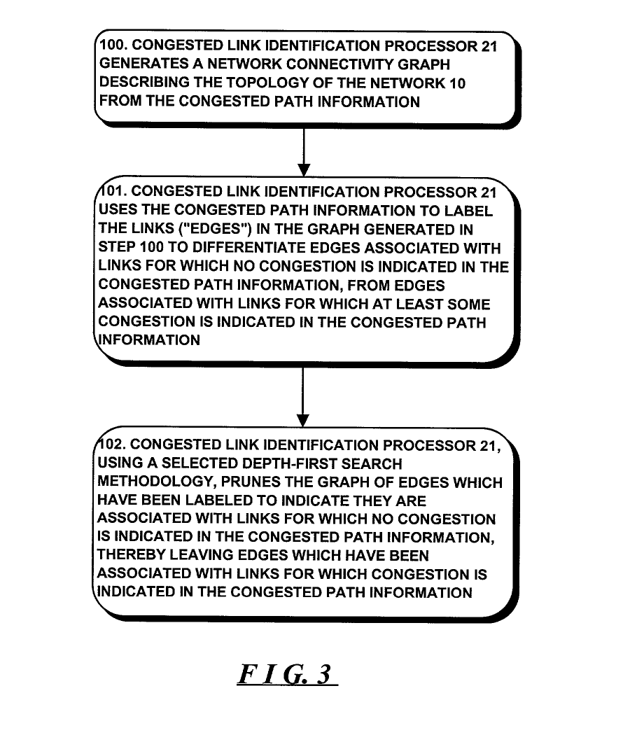

(1) a network connectivity graph generation step (step 100, FIG. 3), in which the congested link identification processor 21 generates a network connectivity graph describing the topology of the network 10 from the congested path information;

(2) an edge link labeling step (step 101) in which the congested link identification processor 21 labels the links (“edges”) in the graph; and

(3) a graph pruning step (step 102), in which the congested link identification processor prunes the graph of edges associated with links that are not congested.

At the end of the graph pruning step (step 102), the only edges remaining will be the edges that are associated with links that are congested.

In the network connectivity graph generation step, the congested link identification processor 21 generates the network connectivity graph to include a plurality of vertices (corresponding to switching nodes) and edges (corresponding to the links 14(m₁)(m₂)), generally with the same topology as the network 10 to the extent that the congestion detection agents 20(n) report links 14(m₁)(m₂) that are congested and links that are not congested. Generally, that will be expected to be all of the links, but if, in fact, a link is not used for any paths over which message packets are transferred while the congestion detection agents 20(n) are accumulating the congested path information, those links will not be represented in the network connectivity graph generated by the congested link identification processor 21. For example, if, while the congestion detection agents 20(n) are gathering the congested path information, no message packets are transmitted over the link 14(1)(2) or 14(2)(1) of communication link 13(1)(2), during the network connectivity generation step, the network connectivity graph will not include an edge associated with the link or communication link. Similarly, if, while the congestion detection agents 20(n) are gathering congested path information, no message packets are transferred through a particular switching node 12(m), the congested link identification processor 21 will not provide a vertex associated with the particular switching node 12(m).

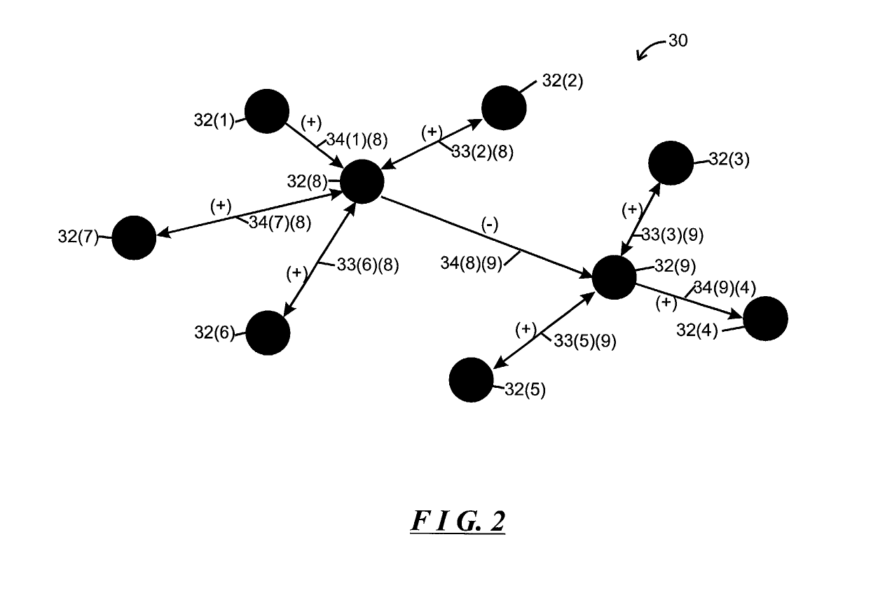

FIG. 2 depicts an illustrative network connectivity graph 30 generated by the congested link identification processor 21 during the network connectivity graph generation step. In with the network 10 described above in connection with FIG. 1, and assuming that the only message packet traffic is that described above, the congested link identification processor 21 will generate a graph as depicted in FIG. 2. With reference to FIG. 2, the illustrative network connectivity graph includes a plurality of nodes 31(1) through 32(9) (generally identified by reference numeral 32(m)) interconnected by edges 33(m₁)(m₂). The edges interconnect the respective nodes in the same pattern as the communication links 13(m₁)(m₂) interconnect the switching nodes 12(m), with the exception that there are no edges for communication links 13(m₁)(m₂) for which there is no congested link information. Accordingly, there are no edges for communication links 13(1)(7), 13(1)(2), 13(6)(7), 13(5)(6), 13(2)(3) and 13(3)(4). As with the communication links, each edge 33(m₁)(m₂) may actually consist of two directional edges 34(m₁)(m₂) each relating to the respective direction of the links 14(m₁)(m₂) comprising a communication link 13(m₁)(m₂); in that case, the directional edge 34(8)(9) will be provided in the network connectivity graph 30, but not a directional edge 34(9)(8), since there is no congested link information for that directional edge.

In the edge link labeling step, the congested link identification processor 21 labels each edge. In one embodiment, the congested link identification processor labels each edge with one of two labels, namely, a (+) if at least some of the congested path information for the edge indicated that the edge was not congested, or a (−) if all of the congested link information for the edge indicated that the edge was congested. Each direction edge 34(m₁)(m₂) will be labeled independently. Accordingly, since, for all of the direction edges 34(m₁)(m₂) in the graph, except for direction edge 34(8)(9), congested path information from at least one congestion detection agent 20(n) indicates that the links 14(m₁)(m₂) associated with the edges 34(m₁)(m₂) are not congested, those edges will be associated with the (+) label. On the other hand, for direction edge 34(8)(9), all of the congested path information from the congestion detection agents 20(n) related to that edge indicates that the edge is congested, and so that edge will be associated with the (−) label.

Finally, in the graph pruning step, the congested link identification processor 21 will prune the network connectivity graph to identify the direction edge or edges 34(m₁)(m₂) that are congested, if any. In that operation, the congested link identification processor 21 selects one of the vertices 32(m) as a root of a tree formed with the other vertices, and performs a depth-first search from the vertices that form leaves of the tree up to the root. As the congested link identification processor 21 proceeds up the tree, it will eliminate edges that are labeled (+). If the congested link identification processor 21 reaches an edge that is labeled (−), it will stop and select another leaf vertex 32(m) from which to start a search, and repeat these operations. After the congested link identification processor 21 has performed searches in connection with all of the leaf vertices, it can select another vertex as root and repeat the operations. After all of the edges that are labeled (+) have been removed, the edges that are labeled (−) will remain and the congested link identification processor 21 will identify those, if any, as being congested.

Using the illustrative network connectivity graph 30 depicted in FIG. 2, if, for example, the congested link identification processor 21 initially selects vertex 32(8) as the root of the tree, it can start with, for example, vertex 32(3) as leaf vertex. In that case, since edge 33(3)(9) is labeled (+), it will move up to vertex 32(9) and, since edge 33(3)(9) is labeled (+), remove the edge 33(3)(9). Since the edge 34(8)(9) is labeled (−), it will stop at that edge. Thereafter, if the congested link identification processor 21 selects vertex 32(4) as leaf, it will repeat the operations described above in connection with vertex 32(3). That is, since edge 34(9)(4) is labeled (+), it will move to vertex 32(9) and remove the edge 34(9)(4) and, since edge 34(8)(9) is labeled (−), stop at vertex 32(9). The congested link identification processor 21 can repeat these operations for all of the leaf vertices and, when complete, the only edge remaining will be edge 34(8)(9), which, as noted above, is associated with the direction link 14(8)(9). As noted above, that direction link 14(8)(9) is the congested link, and the congested link identification processor 21 will identify it as such.

The invention provides a number of advantages. In particular, the invention provides an arrangement for identifying congested communication links in a network based on processing in connection with congestion information indicating whether certain paths, such as confections or connections, through the network over which message packets are transferred are congested or are not congested. Since the arrangement makes use of congestion information for respective paths in the network, it will be appreciated that the arrangement can identify congested links in complicated networks without requiring information from the switching nodes 12(m) themselves.

It will be appreciated that a number of modifications may be made to the arrangement as described above. For example, although the information utilization devices 11(n) have been described as individual devices each connected individually to a switching node 12(m), it will be appreciated that an information utilization device 11(n) may comprise a local area network or subnetwork, a connection to a wide area network, or any other arrangement that can transmit message packets to and/or receive message packets from a switching node 12(m).

In addition, it will be appreciated that the communication links 13(m₁)(m₂) may comprise any convenient medium for transferring message packets, including, but not limited to, wires, optical fibers and the like.

Furthermore, it will be appreciated that the congested link identification arrangement as described above can partition the congested link information according to time period, including, for example, particular times of day and particular days of the week, and determine whether particular links are consistently congested at particular times of day, particular days of the week, and so forth. This may occur if, for example, a number of people in an organization are engaged in performing a particular type of operation, in connection with information stored in particular locations. By identifying particular communication links that are congested during particular time periods a system administrator may be able to, for example, enable certain paths (that is, connections) that use the congested communication links to be re-routed over other communication links to alleviate the congestion.

Furthermore, it will be appreciated that the congested link identification processor 21 can use any conventional methodology in connection with the individual steps described above in connection with FIG. 3.

It will be appreciated that a system in accordance with the invention can be constructed in whole or in part from special purpose hardware or a general purpose computer system, or any combination thereof, any portion of which may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and hi scope of the invention.

What is claimed as new and desired to be secured by letters patent of the United States is:

1. A congested link identification system configured to be used in connection with a network for facilitating transfer of message packets among a plurality of information utilization devices, the network comprising a plurality of switching nodes interconnected by a plurality of communication links, at least some of said information utilization devices being configured to transfer message packets thereamong over paths through said network, each path comprising at least one communication link, the congested link identification system comprising:
A. a plurality of congestion detection agents each associated with one of said information utilization devices, each congestion detection agent being configured to generate congested path information indicating whether respective paths used by the information utilization device associated with the respective congestion detection information are congested; and
B. a congestion link identification processor configured to process the congestion detection information generated by the congestion detection agents to identify communication links that are congested.

2. A congested link identification system as defined in claim 1 in which at least one of said congestion detection agents is configured to generate congested path information in connection with one of said paths utilized by the information utilization device with which said at least one of said congestion detection agents is associated, the congested path information being in relation to the time period for at least one message packet transferred over said path.

3. A congested link identification system as defined in claim 1 in which at least one of said congestion detection agents is configured to generate congested path information in connection with congestion information received by the information utilization device with which said at least one of said congestion detection agents is associated.

4. A congested link identification system as defined in claim 1 in which said congestion link identification processor is configured to determine that a communication link is congested if congested path information indicates that all paths that utilize said communication link is congested.

5. A congested link identification system as defined in claim 4 in which said congested link identification processor comprises:
A. a network connectivity graph generation module configured to generate a network connectivity graph describing the topology of at least a portion of the network from the congested path information, the network connectivity graph including a plurality of vertices each associated with one of said switching nodes and edges each associated with one of said communication links;
B. an edge link labeling module configured to label the edges in the graph, each edge being labeled as being congested if the congested path information indicates that all of the paths that utilize the communication link associated with that edge are congested, and otherwise labeling the edge not congested; and
C. a graph pruning module configured to prune the graph of edges that are labeled not congested, the edges that are not pruned being congested.

6. A congested link identification system as defined in claim 5 in which the graph pruning module is configured to prune the graph using a depth first search pruning methodology.

7. A congested link identification processor configured to process congested path information indicating whether paths in a network are congested, the network comprising a plurality of switching nodes interconnected by communication links, each path including at least one communication link, the congested link identification processor comprising:
A. a network connectivity graph generation module configured to generate a network connectivity graph describing the topology of at least a portion of the network from the congested path information, the network connectivity graph including a plurality of vertices each associated with one of said switching nodes and edges each associated with one of said communication links;
B. an edge link labeling module configured to label the edges in the graph, each edge being labeled as being congested if the congested path information indicates that all of the paths that utilize the communication link associated with that edge are congested, and otherwise labeling the edge not congested; and
C. a graph pruning module configured to prune the graph of edges that are labeled not congested, the edges that are not pruned being congested.

8. A congested link identification system as defined in claim 7 in which the graph pruning module is configured to prune the graph using a depth first search pruning methodology.

9. A method of detecting congested communication links in a network, the network facilitating transfer of message packets among a plurality of information utilization devices, the network comprising a plurality of switching nodes interconnected by a plurality of communication links, at least some of said information utilization devices being configured to transfer message packets thereamong over paths through said network, each path comprising at least one communication link, the method comprising the steps of:
A. generating in connection with each of said information utilization devices, congested path information indicating whether respective paths used by the respective information utilization device are congested; and
B processing the congestion detection information generated by the congestion detection agents to identify communication links that are congested.

10. A method as defined in claim 9 in which congested path information is generated in connection with one of said paths utilized by the respective information utilization device, the congested path information being in relation to the time period for at least one message packet transferred over said path.

11. A method as defined in claim 9 in which congested path information is generated in connection with congestion information received by the respective information utilization device.

12. A method as defined in claim 9 in which said congestion link identification processor is configured to determine that a communication link is congested if congested path information indicates that all paths that utilize said communication link is congested.

13. A method as defined in claim 12 in which said congested link identification step comprises the steps of:
A. generating a network connectivity graph describing the topology of at least a portion of the network from the congested path information, the network connectivity graph including a plurality of vertices each associated with one of said switching nodes and edges each associated with one of said communication links;
B. labeling the edges in the graph, each edge being labeled as being congested if the congested path information indicates that all of the paths that utilize the communication link associated with that edge are congested, and otherwise labeling the edge not congested; and
C. pruning the graph of edges that are labeled not congested, the edges that are not pruned being congested.

14. A method as defined in claim 13 in which the graph pruning step includes the step of pruning the graph using a depth first search pruning methodology.

15. A method of processing congested path information indicating whether paths in a network are congested, the network comprising a plurality of switching nodes interconnected by communication links, each path including at least one communication link, the method comprising the steps of:
A. generating a network connectivity graph describing the topology of at least a portion of the network from the congested path information, the network connectivity graph including a plurality of vertices each associated with one of said switching nodes and edges each associated with one of said communication links;
B. labeling the edges in the graph, each edge being labeled as being congested if the congested path information indicates that all of the paths that utilize the communication link associated with that edge are congested, and otherwise labeling the edge not congested; and
C. pruning the graph of edges that are labeled not congested, the edges that are not pruned being congested.

16. A method as defined in claim 15 in which the graph pruning step includes the step of pruning the graph using a depth first search pruning methodology.

17. A computer program product for use in connection with a computer to provide a congested link identification system configured to be used in connection with a network for facilitating transfer of message packets among a plurality of information utilization devices, the network comprising a plurality of switching nodes interconnected by a plurality of communication links, at least some of said information utilization devices being configured to transfer message packets thereamong over paths through said network, each path comprising at least one communication link, the computer program product comprising a computer-readable medium having encoded thereon:
A. a congestion detection agent module configured to enable said computer to provide a plurality of congestion detection agents each for association with one of said information utilization devices, each congestion detection agent being configured to generate congested path information indicating whether respective paths used by the information utilization device associated with the respective congestion detection information are congested; and
B a congestion link identification processor module configured to enable the computer to process the congestion detection information generated by the congestion detection agents to identify communication links that are congested.

18. A computer program product as defined in claim 17 in which at least one of said congestion detection agents is configured to generate congested path information in connection with one of said paths utilized by the information utilization device with which said at least one of said congestion detection agents is associated, the congested path information being in relation to the time period for at least one message packet transferred over said path.

19. A computer program product as defined in claim 17 in which at least one of said congestion detection agents is configured to generate congested path information in connection with congestion information received by the information utilization device with which said at least one of said congestion detection agents is associated.

20. A computer program product as defined in claim 17 in which said congestion link identification processor module is configured to enable the computer to determine that a communication link is congested if congested path information indicates that all paths that utilize said communication link is congested.

21. A computer program product as defined in claim 20 in which said congested link identification processor module comprises:
A. a network connectivity graph generation module configured to enable the computer to generate a network connectivity graph describing the topology of at least a portion of the network from the congested path information, the network connectivity graph including a plurality of vertices each associated with one of said switching nodes and edges each associated with one of said communication links;
B. an edge link labeling module configured to enable the computer to label the edges in the graph, each edge being labeled as being congested if the congested path information indicates that all of the paths that utilize the communication link associated with that edge are congested, and otherwise labeling the edge not congested; and
C. a graph pruning module configured to enable the computer to prune the graph of edges that are labeled not congested, the edges that are not pruned being congested.

22. A congested link identification system as defined in claim 21 in which the graph pruning module is configured to enable the computer to prune the graph using a depth first search pruning methodology.

23. A computer program product for use in connection with a computer to provide a congested link identification processor configured to process congested path information indicating whether paths in a network are congested, the network comprising a plurality of switching nodes interconnected by communication links, each path including at least one communication link, the computer program product comprising a computer readable medium having encoded thereon:
A. a network connectivity graph generation module configured to enable the computer to generate a network connectivity graph describing the topology of at least a portion of the network from the congested path information, the network connectivity graph including a plurality of vertices each associated with one of said switching nodes and edges each associated with one of said communication links;
B. an edge link labeling module configured to enable the computer to label the edges in the graph, each edge being labeled as being congested if the congested path information indicates that all of the paths that utilize the communication link associated with that edge are congested, and otherwise labeling the edge not congested; and
C. a graph pruning module configured to enable the computer to prune the graph of edges that are labeled not congested, the edges that are not pruned being congested.

24. A computer program product as defined in claim 23 in which the graph pruning module is configured to enable the computer to prune the graph using a depth first search pruning methodology.
